(19) United States
(12) Patent Application Publication
(10) Pub. No.: US 2025/0286324 A1
(43) Pub. Date: Sep. 11, 2025

(54) ELECTRICAL CONNECTOR WITH IMPROVED HIGH FREQUENCY PERFORMANCE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: HONG-JING LUO, Shenzhen (CN)

(21) Appl. No.: 19/073,758

(22) Filed: Mar. 7, 2025

(30) Foreign Application Priority Data
Mar. 11, 2024 (CN) 202410275129.7

(51) Int. Cl. H01R 13/6586

(52) U.S. Cl. CPC H01R 13/6586

(57) ABSTRACT

An electrical connector includes: an insulating housing having a mating groove; and at least one terminal module fixed in the insulating housing and having an insulating bar, a row of terminals arranged along a first direction, a grounding member, and an absorbing member, the row of terminals including plural pairs of signal terminals and plural grounding terminals, the terminals comprising fixing portions fixed in the insulating bar and elastic arms extending into the mating groove, wherein the grounding member and the absorbing member are located at opposite sides of the terminal module in a second direction perpendicular to the first direction, the grounding member has plural grounding fingers abutting against corresponding grounding terminals, and the absorbing member is spaced from pairs of signal terminals and the grounding terminals.

### BACKGROUND OF THE INVENTION

### Field of the Invention

The present invention relates to an electrical connector with improved high frequency performance.

### Description of Related Arts

U.S. Pat. No. 10,320,102 discloses an electrical connector which comprises a housing and two rows of contacts retained in the housing. Each contact comprises an intermediate section and a mating end and a terminating end extending upwardly and downwardly from two ends of the intermediate section respectively. The contacts comprise signal contacts and grounding contacts, signal crosstalk resonance would often occur between signal terminals during high-frequency signal transmitting.

Therefore, it is necessary to provide an electrical connector with an improved high frequency performance.

### SUMMARY OF THE INVENTION

The object of the present invention is to provide an electrical connector with an improved high frequency performance.

To achieve the above object, an electrical connector comprises: an insulating housing having a mating groove; and at least one terminal module fixed in the insulating housing and comprising an insulating bar, a row of terminals arranged along a first direction, a grounding member, and an absorbing member, the row of terminals comprising plural pairs of signal terminals for transmitting differential signals and plural grounding terminals, the terminals comprising fixing portions fixed in the insulating bar and elastic arms extending into the mating groove, wherein the grounding member and the absorbing member are located at opposite sides of the terminal module in a second direction perpendicular to the first direction, the grounding member has plural grounding fingers abutting against corresponding grounding terminals, and the absorbing member is spaced from pairs of signal terminals and the grounding terminals.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector of an embodiment of this present invention;

FIG. 2 is another perspective view of the electrical connector in FIG. 1;

FIG. 3 is an exploded perspective view of the electrical connector in FIG. 1;

FIG. 4 is another perspective view of an insulating housing in FIG. 3;

FIG. 5 is another perspective view of two terminal modules in FIG. 3;

FIG. 6 is a cross-sectional view of the electrical connector along line A-A of FIG. 5;

FIG. 7 is a perspective view of two terminal modules in FIG. 5, wherein the two terminal modules are separated from each other;

FIG. 8 is a front view of the terminal module 20A in FIG. 7;

FIG. 9 is a rear view of the terminal module 20A in FIG. 7;

FIG. 10 is an exploded perspective view of the terminal module 20B in FIG. 7;

FIG. 11 is a further exploded perspective view of the terminal module in FIG. 10;

FIG. 12 is a perspective view of the terminal module 20B, wherein the insulating housing is removed;

FIG. 13 is a front view of the terminal module 20B in FIG. 12; and

FIG. 14 is a side view of the terminal module 20B in FIG. 12.

### DETAILED DESCRIPTION OF THE PREFERRED EMBODIMENT

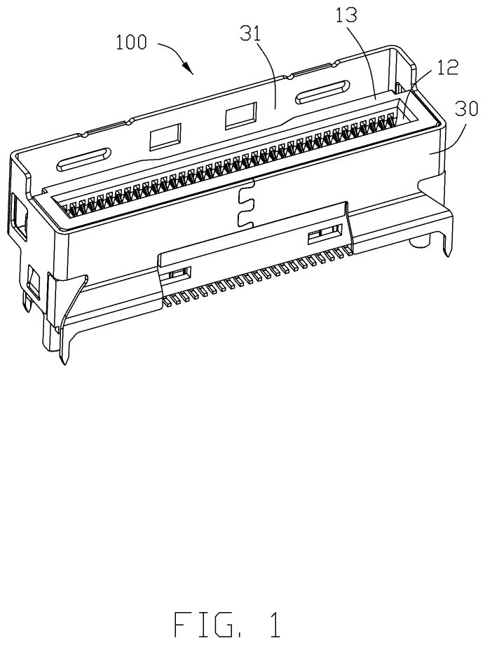

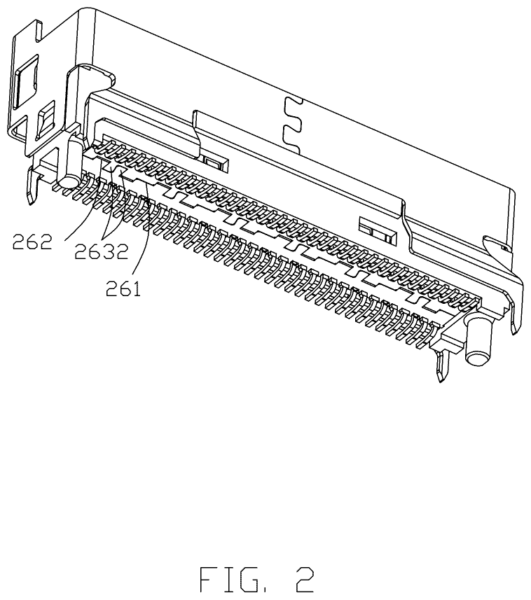

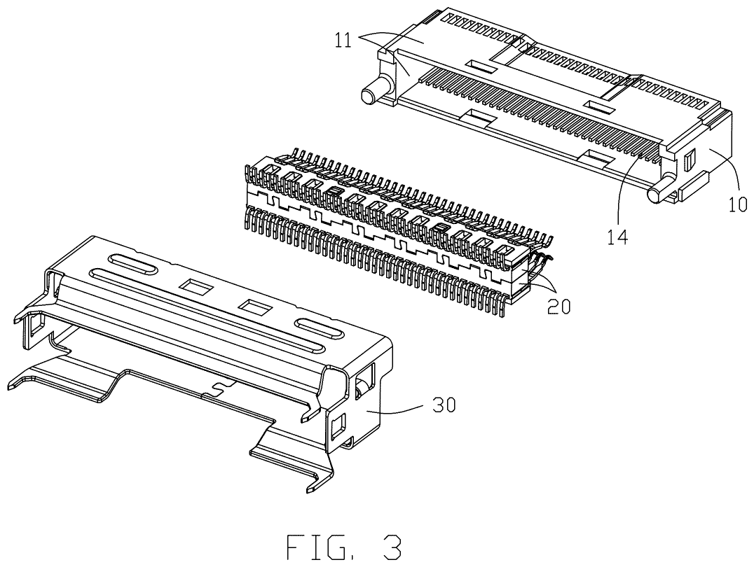

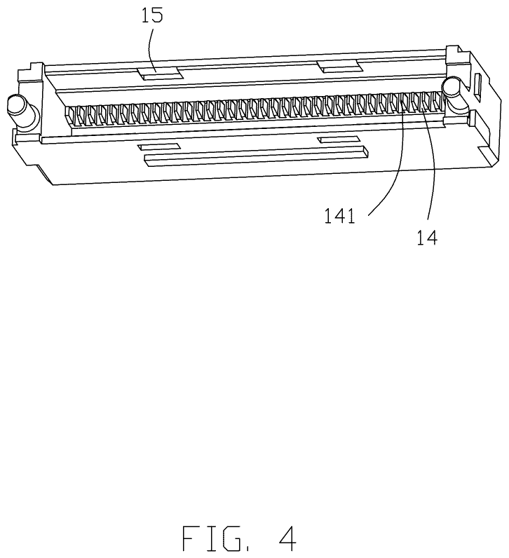

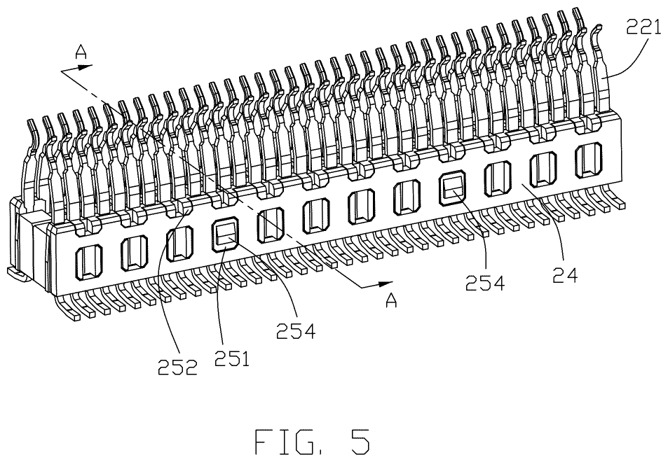

Referring to FIGS. 1-3, an electrical connector 100 of one embodiment of this present invention is illustrated, which is adapted for mounting on a circuit board. The electrical connector 100 is used for transmitting high frequency signals, and includes an insulating housing 10 with an upper face/mating face 13, two terminal modules 20 retained in the insulating housing 10 and a mental shell 30. The insulating housing 10 extends along a longitudinal direction and comprises four side walls 11 and a longitudinal mating groove 12 formed by the four side walls 11, and the mating groove 12 opens through the mating face 13. The two terminals modules 20 are assembled together as a whole and then are assembled into the insulating housing 10, the two terminal modules are located at opposite sides of the mating groove 12. Two long side walls of the four side walls 11 have plural terminal grooves 14, and every two neighboring terminal grooves are separated by a rib 141. Referring to FIGS. 4-5, contacting portions 221 of the two terminal modules 20 protrude into the mating groove 12 for contacting with a mating connector. The shell 30 surrounds the four side walls 11 outwardly and are spaced from one of the four side walls to form an aligning groove 31. Preferably, the aligning groove 31 is formed between the shell 30 and one long side wall.

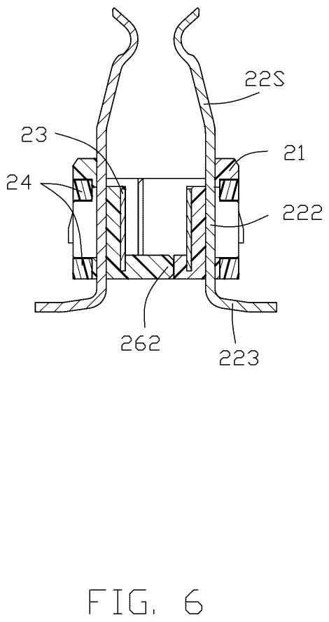

Referring to FIGS. 5-8, the two terminal modules 20 have a same structure or are substantially the same, so the two terminal modules can share a same mold. Referring to FIG. 6, the two terminal modules 20 are in mirror image symmetry, so the terminals of one of the two terminal modules are aligned with the terminals of another terminal module one by one for a better transmitting of high frequency signals. Each terminal module 20 is injection molded with an absorbing member 24 at an outside thereof to absorb external noise. A grounding member 23 is embedded in the insulating housing 10 at each inside of the two terminal modules 20 to avoid signal interference between the two rows of signal terminals. The grounding member 23 abuts against corresponding grounding terminals 22G of the terminal module 20 to suppress resonance and reduce FEXT of signal transmitting, and thus, a SI performance of the electrical connector 100 can be improved.

The terminal module 20 will be introduced in detail hereinafter. In order to distinguish the two terminal modules conveniently, one of the terminal modules is labeled 20A and the other terminal module is labeled 20B.

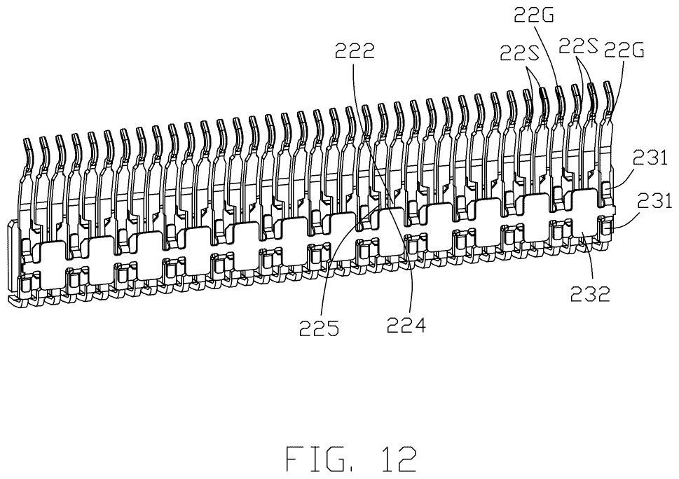

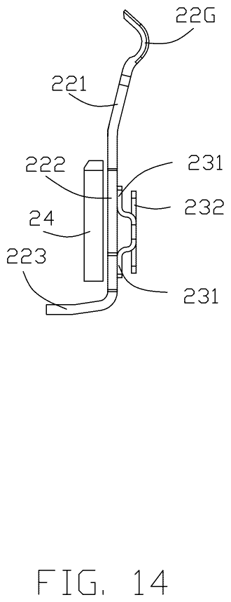

Referring to FIGS. 12-15, each of the terminal modules comprises an insulating bar 21, a row of terminals 22 arranged along a first direction or the longitudinal direction, the grounding member 23 and the absorbing member 24. The grounding member 23 and the absorbing member 24 extend along the longitudinal direction and are located at opposite sides of the corresponding row of terminals 22. The row of terminals 22 comprises plural pairs of signal terminals 20S for transmitting differential signals, and grounding terminals 22G between two neighboring pairs of signal terminals 20S. Each pair of signal terminals 20S comprises two adjacent signal terminals 20S. In order to describe conveniently, the sides of the terminal modules 20 that are close to each other is configured as insides 211 and the sides of the two terminal modules 20 that are far away from each other are configured as outsides 212. The grounding member 23 is located at the inside 211 of the terminal module 20 and has plural grounding fingers 231 which abut against corresponding grounding terminals 22G one by one. The absorbing member 24 is located at the outside 212 of the terminal module 20 and does not contact with the signal terminals 22S and grounding terminals 22G as clearly shown in FIG. 14. Referring to FIG. 6, each terminal 22 comprises a contacting portion 221, a fixing portion 222 and a tail portion 223. The fixing portions 222 of the terminals 22 are embedded and retained in the insulating bar 21, the contacting portions 221 extend out of an upper face of the insulating bar 21 and the tail portions 223 extend out of a lower face of the bar 21. The grounding member 23 has two rows of grounding fingers 231, and one row of the grounding fingers 231 extends upwardly and the other row of the grounding fingers extend downwardly. The grounding fingers 231 extending upward are aligned with the grounding fingers 231 extending downward one by one in an upper and lower direction. In order to describe conveniently, a grounding finger extending upwardly and a grounding finger extending downward are defined as a pair of grounding fingers. A pair of grounding fingers contact with the same fixing portion 222 of a grounding terminal 22G. The grounding member 23 has plural shielding portions 232, and each shielding portion is between every two neighboring pairs of grounding fingers 231 and shields corresponding pair of signal terminal 20S. The absorbing member 24 extends beyond the grounding member 23 both in an upper direction and a lower direction when seen from the longitudinal direction, as clearly shown in FIG. 14.

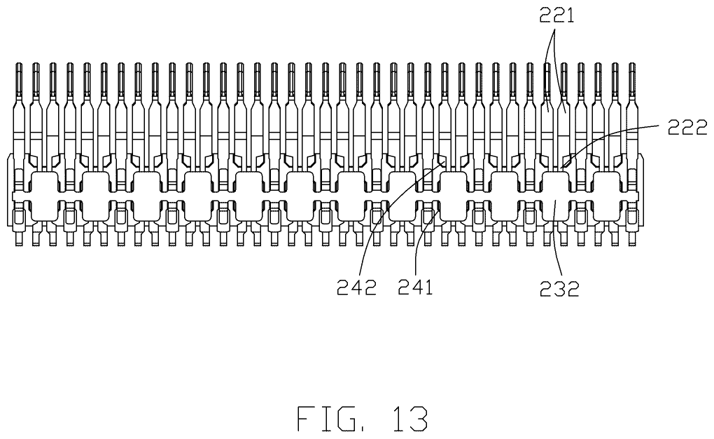

Referring to FIGS. 12-13, each of the signal terminals of the pair of signal terminals has an outer edge 225 and an inner edge 224 opposite to the outer edge. The inner edges 224 of the two signal terminals of the pair are close to each other. The outside edge 225 of the fixing portion 222 shrinks inwardly relative to the outside edge 225 of the contacting portion 221 so that a width of the fixing portion 222 becomes less to improve high frequency performance of the electrical connector 100. For the grounding terminal 22G, a width of the contacting portion 221 and a width of the fixing portion 222 are almost the same. Referring to FIG. 13, the shielding portion 232 of the grounding member faces and shields corresponding pair of signal terminals 20S. The absorbing member 24 has plural first openings 241 and second openings 242 over the corresponding first openings 241. As described above, the shielding portion 232 faces and shields corresponding pair of signal terminal 20S to reduce signal interference between the two rows of terminals 22. To prevent the absorbing member 24 from absorbing the energy of normal signal transmission, the absorbing member 24 is kept away from the signal terminals 22 as soon as possible by the first openings 241 and the second openings 242 facing a corresponding pair of signal terminals 20S. Preferably, to keep away from the signal terminals 22, each first opening 241 faces and aligns with shielding portions 232 of corresponding pair of signal terminals 20S.

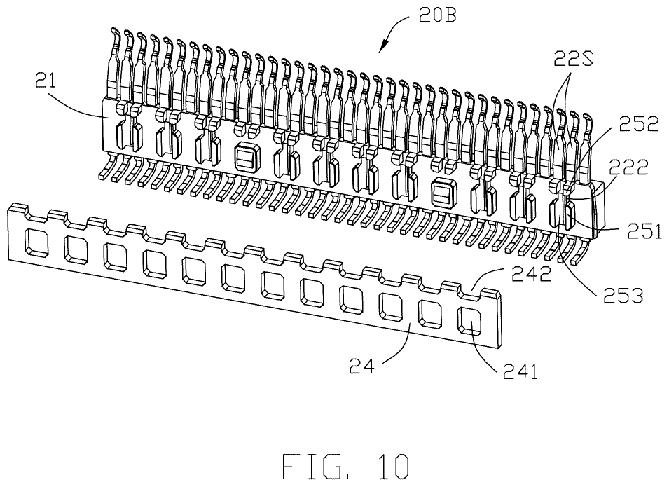

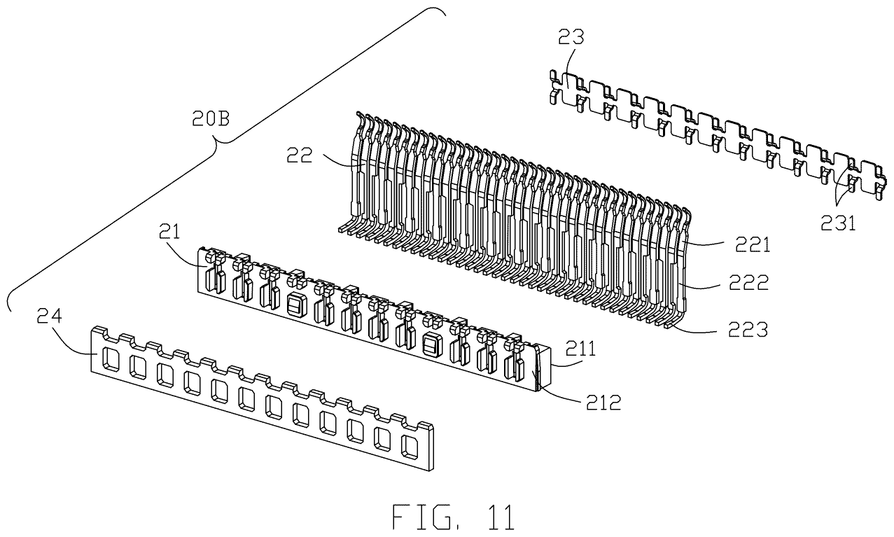

Assembling process of the electrical connector 100 is introduced. As shown in FIGS. 10-11, a row of terminals 22 and the grounding member 23 are positioned, and insulating material is injected to the terminals 22 and the grounding member 23 and then is cooled to form the insulating bar 2. Absorbing material is injected at an outside of the insulating bar 21 and then is cooled to form the absorbing member 24. For better combination of the insulating bar 21 and the absorbing member 24, the insulating bar 21 is provided with plural receiving recesses and bumps at the outside thereof, the receiving grooves accommodate the absorbing material and the bumps go through corresponding openings of the absorbing member 24. Preferably, the insulating bar 21 has plural first bumps 251 which go through the corresponding first openings 241. The first openings 241 align with corresponding pairs of signal terminal 20S one by one. The first bump 251 has a groove 253 penetrates a middle portion thereof and extends along the upper and lower direction.

The fixing portions 222 of the signal terminals 20S are exposed in a lower portion of the corresponding grooves 253, seen clearly in FIG. 10. The insulating bar 21 has plural second bumps 252 above the corresponding first bumps 251, and the second bumps 252 go through the corresponding second openings 242 one by one. Similar to the first openings 241, the second openings 242 are aligned with the corresponding pairs of signal terminal 20S one by one. Similar to the first bump 251, the second bump 252 has a groove (not labeled) which aligns and communicates with the corresponding groove 253. For better fix of the signal terminals, the signal terminal is not exposed in the corresponding groove of the second bump 252. That is to say, the pair of signal terminals is embedded in the second bump 252. Except for the first openings 241 and the second openings 242, the absorbing member 24 has no other openings and almost covers the whole outside of the insulating bar 21. Combined with FIG. 4, two of the first bumps 251 are provided with locking blocks 254 instead of the grooves 253, the locking blocks 254 go through the corresponding first openings 241 and are bucked in corresponding locking holes 15 of the side walls 11 of the insulating housing 10.

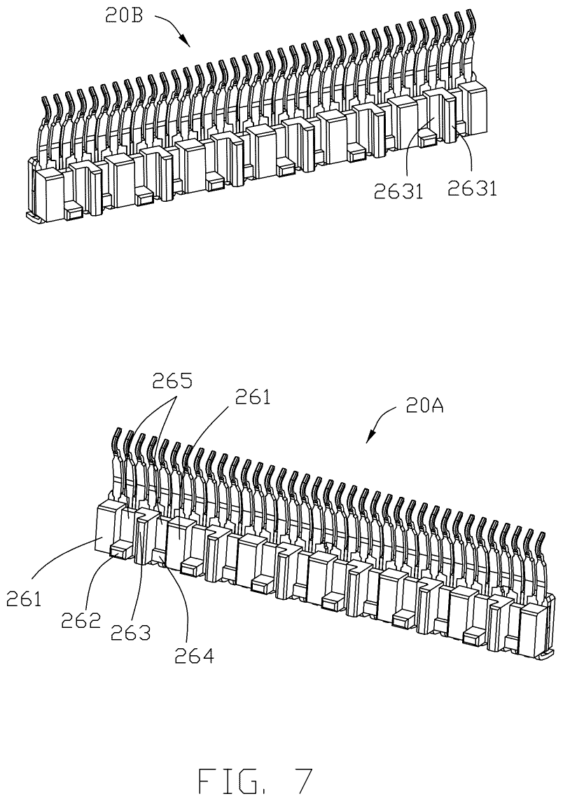

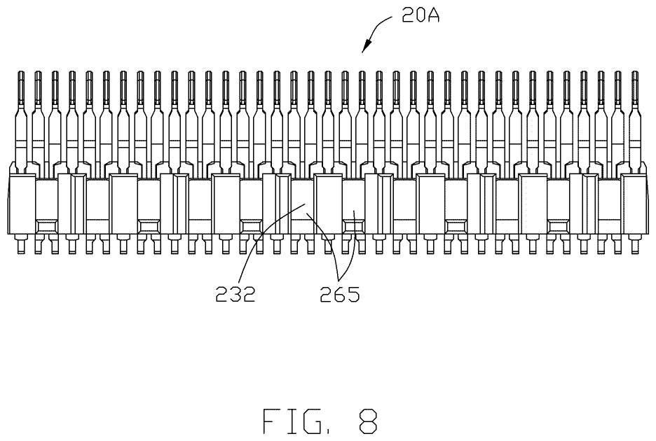

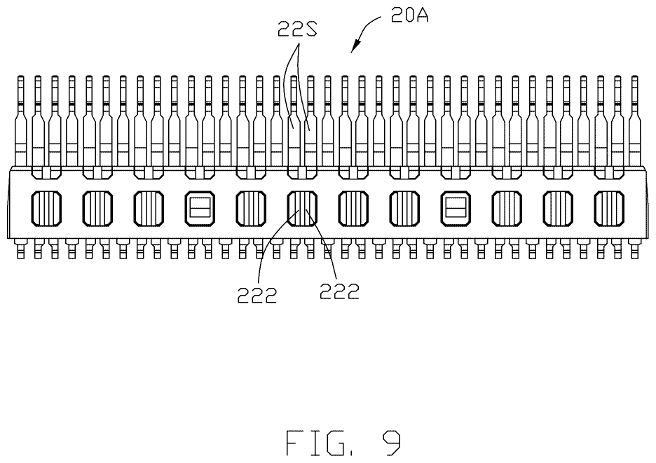

Referring to FIGS. 7-8, the insulating bar 21 has a reference face 261, plural horizontal ribs 262, plural vertical ribs 263 and plural horizontal grooves 264. The vertical ribs 263 and the horizontal ribs 262 protrudes from the reference face 261 along a lateral direction perpendicular to the longitudinal direction. The horizontal grooves 264 recess from the reference face 261 inwardly in the lateral direction. Each vertical rib 263 comprises a recessed portion 2631 and a bulged portion 2632. The horizontal ribs 262 of one terminal module cooperate with the horizontal grooves 264 of the other terminal module and the recessed portions 2631 of one terminal module cooperate with the bulged portion 2632 of another terminal module 20 when the two terminal modules are assembled together. The horizontal ribs 262 and the horizontal grooves 264 are located at a lower portion of the insulating bar 21. Vertical grooves 265 are located above the horizontal ribs 262 or the horizontal grooves 264 and face the pairs of signal terminal 20S one by one correspondingly, and thus, a thickness of the insulating bar 21 facing the pair of signal terminal is thinner. As the contacting portions 221 and the tail portions 223 of the terminals 22 are exposed in the air and the fixing portion 222 are embedded in the insulating bar 21, a dielectric constant of the fixing portion 222 is different from that of the contacting portion 221 and the tail portion 223. The thinner the insulating bar is, the minimizer of a difference of the dielectric constant between the fixing portion 222 and the contacting portion 221 is. Grounding fingers 231 of the grounding member 23 are aligned with the reference faces 261 and the vertical ribs 263 in the lateral direction, so the insulating bar at the reference face 261 and the vertical rib is thick enough to support when the grounding fingers 231 keep contact with the fixing portion 222 of the corresponding grounding terminals, and the shielding portions 232 are exposed to the vertical grooves 265, as shown clearly in FIG. 9. As the vertical groove 265 is made by removing a tool for fixing the shielding portion 232, the vertical groove 265 can not only improve the high frequency performance but also fix the grounding member 23. In other embodiments, the shielding portion 232 may be not exposed in the vertical groove 265.

The above-mentioned embodiments are only preferred embodiments of the present invention, and should not limit the scope of the present invention, any simple equivalent changes and modifications made according to the claims of the present invention and the contents of the description should still belong to the present invention.

1. An electrical connector comprising:
an insulating housing defining a mating groove; and
two terminal modules fixed in the insulating housing and located at opposite sides of the mating groove, each terminal module comprising an insulating bar, a row of terminals arranged along a first direction, a grounding member, and an absorbing member, each row of the terminals comprising plural pairs of signal terminals for transmitting differential signals and at least one grounding terminal located between two adjacent pairs of signal terminals, each differential terminal pair comprising two signal terminals;
wherein the grounding member is located at an inside of each of the two terminal modules proximate to the mating groove and has plural grounding fingers, the grounding fingers abut against corresponding grounding terminals, and the absorbing member is located at an outside of each of the two terminal modules opposite to the inside and separates from the signal terminals.

2. The electrical connector as claimed in claim 1, wherein the absorbing member separates from the grounding terminals.

3. The electrical connector as claimed in claim 1, wherein the absorbing member is formed at an outside of the insulating bar by an injection molding process.

4. The electrical connector as claimed in claim 2, wherein the insulating bar has plural first bumps extending from an outside thereof, and the absorbing member has plural first openings, the first bumps are received in corresponding first openings, and the pairs of signal terminals face corresponding first openings in a lateral direction perpendicular to the absorbing member.

5. The electrical connector as claimed in claim 4, wherein each of the first bumps has a groove extending along a second direction in which the terminal extends, and the pairs of signal terminals are exposed to corresponding grooves of the first bumps.

6. The electrical connector as claimed in claim 5, wherein the insulating bar has plural second bumps extending from the outside thereof, the second bumps are located above corresponding first bumps, the absorbing member has plural second openings, the second bumps are latched in corresponding second openings, and the second openings are aligned with and face corresponding pairs of signal terminals.

7. The electrical connector as claimed in claim 6, wherein the absorbing member covers the outside of the insulating bar wholly except the first openings and the second openings.

8. The electrical connector as claimed in claim 1, wherein each of the terminals comprises a fixing portion embedded in the insulating bar, a contacting portion and a tail portion extending out of the insulating bar respectively, each pair of signal terminals have inside edges closer to each other and outside edges opposite to corresponding inside edges, and the outside edge of each of the signal terminals is recessed inwardly at the fixing portion.

9. The electrical connector as claimed in claim 1, wherein the insulating bar has a reference face, plural horizontal ribs, plural vertical ribs and plural horizontal grooves at an inside thereof, and the horizontal ribs and the vertical ribs protrude outwardly relative to the reference face, the horizontal grooves recess relative to the reference face inwardly, each vertical rib comprises a recessed portion and a bulged portion, and the bulged portions of one of the two terminal modules cooperate with corresponding recessed portions of the other of the two terminal modules.

10. The electrical connector as claimed in claim 9, wherein the insulating bar has plural vertical grooves at an inside thereof, the horizontal grooves and the horizontal ribs are near a lower portion of the insulating bar, and each of the vertical grooves is located above the horizontal groove or the horizontal rib.

11. An electrical connector comprising:
an insulating housing having a mating groove; and
at least one terminal module fixed in the insulating housing and comprising an insulating bar, a row of terminals arranged along a first direction, a grounding member, and an absorbing member, the row of terminals comprising plural pairs of signal terminals for transmitting differential signals and plural grounding terminals, the terminals comprising fixing portions fixed in the insulating bar and elastic arms extending into the mating groove;
wherein the grounding member and the absorbing member are located at opposite sides of the terminal module in a second direction perpendicular to the first direction, the grounding member has plural grounding fingers abutting against corresponding grounding terminals, and the absorbing member is spaced from pairs of signal terminals and the grounding terminals.

12. The electrical connector as claimed in claim 11, wherein the insulating bar has plural first bumps, the first bumps are received and retained in corresponding first openings defined on the absorbing member, and the first openings face corresponding pairs of signal terminals in the second direction.

13. The electrical connector as claimed in claim 12, wherein the first bump has a groove extending along a third direction perpendicular to the first direction and the second direction, and parts of corresponding pairs of signal terminals are exposed to the corresponding grooves.

14. The electrical connector as claimed in claim 13, wherein the insulating bar has plural second bumps located above the first bumps, the second bumps are received and retained in corresponding second openings defined on the absorbing member, and the groove extends through corresponding second bump in the third direction.
